(19) United States
(12) Patent Application Publication
(10) Pub. No.: US 2002/0092799 A1
(43) Pub. Date: Jul. 18, 2002

(54) Reclaimer

(76) Inventor: Steinar Storruste, Salina, KS (US)

Correspondence Address: Steinar Storruste, Design Engineering, P.O. Box 522, Rehobeth Beach, DE, 19971, US

(21) Appl. No.: 09/760,987

(22) Filed: Jan. 16, 2001

(51) Int. Cl. B03B 5/64; B07B 11/00

(52) U.S. Cl. 209/460; 209/492; 209/464; 209/458; 209/162

(57) ABSTRACT

A device for reclaiming material, such as used wet ready mixed concrete, having a hopper for receiving the used concrete into a excess of water and floating the suspended cement particles out through a weired overflow for further reclamation while the solid sand and aggregate is augured from the bottom of the hopper for further washing and separation into sand and aggregate for reuse.

### FIELD OF THE INVENTION

The invention as disclosed herein is a reclaimer. More particularly, the invention is a reclaimer for reclaiming or separating materials, such as concrete, containing sand, dirt, aggregate and other such components.

### BACKGROUND OF THE INVENTION

The use of concrete in construction has become pervasive in today's world. Concrete is a wonderful building material, and that, it is a plastic pourable material that hardens into a rigid material in the shape of its forms. The problem with concrete is disposal of access waste product.

In the use of concrete for construction, typical procedure is to construct the necessary forms to contain the concrete in its desired shape to contain an appropriately sized amount of concrete or pour. The size of the pour will vary with the nature and complexity of the particular job. Often it is impossible to pour, for example an entire building at once owing to the size of the building, the concrete pour cannot be completed before the first poured concrete has set up, or, the building is so tall, that the forms at the bottom cannot take the pressure of the concrete above them. Other times, it is just more convenient to perform a job using multiple pours of concrete. When pouring concrete, ideally, an operator would mix the exact amount needed. However, it is difficult to impossible to mix the exact amount. At times when an exact amount is attempted to be mixed, a larger or small amount of water than anticipated will be necessary altering the volume of the batch produced. Because the consequences of having an insufficient amount of concrete are significantly worse than the consequences of having too much concrete, it has become standard practice to mix slightly more concrete than is needed to avoid having insufficient concrete. The excess concrete thus generated becomes waste and can be a disposal problem.

In the past, the excess concrete was disposed of at the job site, often by being buried or was merely poured on the ground and left to harden. Similarly, when the concrete was mixed off-site and trucked to the job site in a ready mix truck, the disposal problem is concentrated at the ready mix plant.

This type of disposal is both wasteful and environmentally incorrect. The burying of concrete to harden near a job site can lead to future problems, such as incomplete compaction of the earth, or unexplained settling of the earth, or even damage to the building from the aforementioned. When the excess concrete is returned to the ready mix plant, the excess concrete can build in to mountains of concrete debris that has no value and is difficult to dispose of economically.

Concrete reclaimers of various sorts have been developed which separate the component parts, e.g., water, sand, gravel, and remaining cement. These typically use a tank with water and a system of placing and a system for removing the cement from the tank. The available reclaimers are bulky, expensive, inefficient and excessively large. Consequently, they are not universally used, especially with smaller cement companies. Such companies still resort to dumping the excess cement out onto the ground where it is damaging to the environment.

Moreover, such reclaimers generally do not join the screen for sorting the gravel to the auger. This causes the screens to wear out quickly as the gravel grates between the screen and auger. Further, the structure of the support for the screen and frequent replacement of the screen adds to the bulk, expense and down time.

These problems with concrete and the need for separation are also prevalent in other situations. For instance, sand and salt collected from roads, mining operations for gravel, sand and other materials from the soil and similar situations.

What is needed is a concrete reclaimer of a size and design that is compact, inexpensive and separates the components effectively. Preferably, the screen is secured to the auger and may be interchangable with other screens. That is, the auger itself provides the support structure for the screen.

### SUMMARY OF THE INVENTION

The present invention is a compact design that separates the aggregate into component parts in a fast, effective and less expensive manner than former reclaimers. With the present invention, the excess wet concrete, or other substance, can be poured or dumped into a water filled hopper where it will not harden due to the excess water. An auger in the bottom of the hopper will remove the sand and rock that settles to the bottom of the hopper while the cement will rise to the surface where it can be removed in an overflow weir.

More specifically, the invention receives the pre-mixed wet concrete for separation and separation of the concrete into its components. The wet pre-mixed concrete is placed in a hopper where the excess water inhibits hardening and tends to float the cement from the heavier sand and aggregate. The heavier components that have settled to the bottom of the hopper are removed with a rotating auger which draws the sand and aggregate up along the side of the of the hopper and above the water level. The water containing the suspended cement will run back into the hopper where it will eventually rise to the surface and be drawn out with the overflow water to be reclaimed.

The sand and aggregate mixture continues to be pulled up along the side of the hopper by the auger. When the sand and aggregate mixture is at a point above the water level in the hopper, it will be will be rewashed under a stream of additional water to remove more of the remaining cement from the sand and aggregate. The rewash water will flow down the auger housing into the hopper and ultimately out through the weirs. The auger will continue to draw the sand and aggregate mixture up from the hopper. In this area, the remaining water will tend to run down the auger housing and out of the sand and aggregate mixture. After the mixture of sand and aggregate has been de-watered, it passed over a screen, which is secured to the auger and rotates therewith, where the smaller particles of sand fall through into a pile and leave the coarser aggregate remaining in the auger. The remaining aggregate is carried by the auger to the terminal end of the auger and fall out of the auger housing into an aggregate pile. The sand and aggregate can then be removed from their respective piles and recycled into new concrete.

This invention while generally intended to be used in reclaiming cement is much broader in scope. Specifically, this invention may also be used to sort rock from sand in mining operations. Further, this reclaimer may be used to separate salt and sand recovered from Springtime roads. In essence this invention separates components based upon size and permits a washing step if desired.

### BRIEF DESCRIPTION OF THE DRAWINGS

FIG. 1 is a partially cut-away overall side view of the concrete reclaimer.

FIG. 2 is a plan overhead view of the concrete reclaimer.

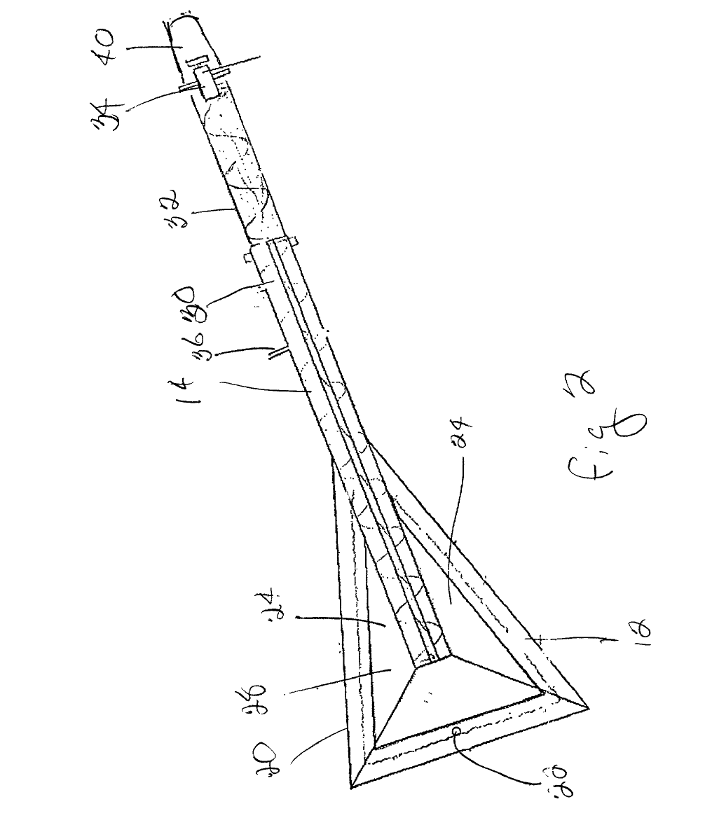

### DESCRIPTION OF THE PREFERRED EMBODIMENT

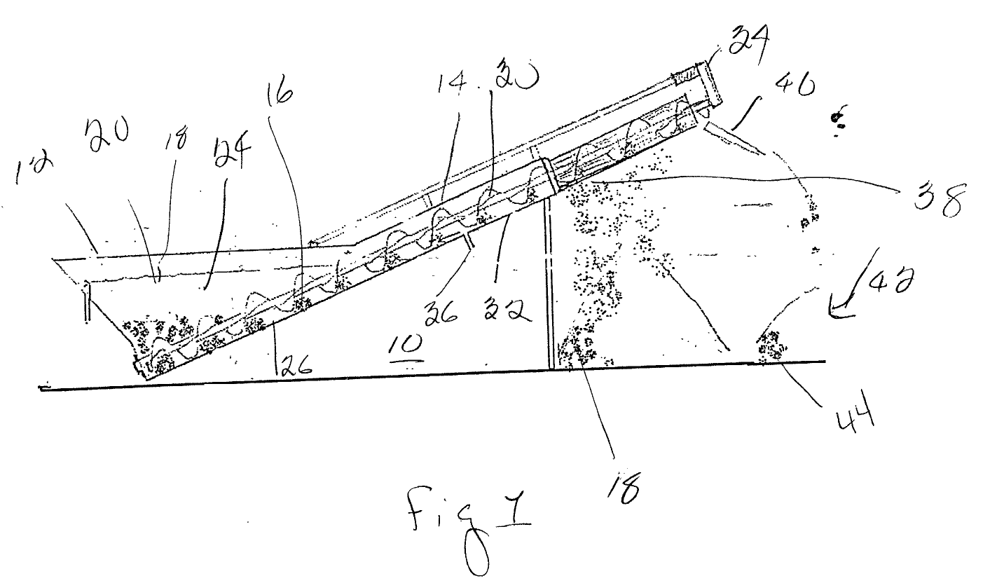

Looking at the drawings, FIG. 1 shows the reclaimer 10 which includes the hopper assembly 12 and the auger assembly 14. The hopper assembly 12 includes the hopper 20 and the overflow weir 22. The hopper 20 may be constructed of any suitable material that has sufficient strength and rigidity to be filled with water 28. Suitable materials would include metal sheets welded or otherwise fastened in an appropriate form, or polymers having the necessary properties. The hopper 20 may be of any suitable shape, but should have angled sides 24 that meet to form a trough 26 to receive the auger assembly 14. Preferably, the hopper 20 is in the form of an inverted irregular tetrahedron, open at the top and resting on one vertex.

The auger assembly 14 includes the auger 30, the auger housing 32, and the drive source 34. The auger 30 is a screw type auger which extends from the bottom of the hopper 20 upwardly along the vertex of two angled sides 24 of the hopper 20 and continues the length of the auger housing 32. The auger housing 32 extends parallel to and along the auger 30 a sufficient length to move the reclaimed components away from the housing for recycling.

The auger housing 32 is shaped to fit closely about the auger 30 such that the rotation of the auger 30 within the auger housing 32 causes the solids 16 to be urged up the auger housing 32 for separation and disposal. The portion of the auger housing 32 that is contained in the hopper 20 may be a separate housing or may formed from the angled sides of the hopper 20, or may be dispensed with in the hopper 20, so long as the auger 30 is able to move the solids 16 along the inclined side and into the auger housing 32 above the hopper 20. The angle of the housing 32 relative to the hopper 20 is not all that critical, although the angle together with the rotation speed of the auger 30, auger diameter and number of augers jointly define the capacity.

The auger 30 draws the solids 16 from the sump of the hopper 20 and upwardly along the auger housing 32 where the solids 16 are first drawn past the wash water nozzle 36 where additional water is added to wash remaining cement or other washable material from the solids. The auger 30 further draws the solids 16 across a screen 38 where the sand 18 and finer particles pass through the screen and are deposited thereunder. After passing over the screen 38, the remaining solids 16 are drawn to the upper of the auger housing 32 and are deposited in another collection area thereunder.

The screen 38 is joined to the auger 30 and rotates therewith. The screen may be held with any suitable means of attachment including screws, nuts and bolts, welding or other such mechanism for attachment. Ideally, the screen 38 is replaceable with a new screen as it becomes worn over time. Attachment of the screen 38 directly to the auger 30 is desirable as gravel does not rub between the auger 30 and screen 38 and thereby cause excessive wear of the screen 38.

The wash water nozzle 36 is of conventional design and is readily available from numerous sources. The water supplied to the water nozzle is typically supplied from domestic or city water available at the site. The amount of water supplied to the water nozzle 36 should be sufficient to wash the remaining cement or other particles from the solids while not overloading the hopper 20 overflow weir 22. The water nozzle 36 is not a necessary component of the invention 10 and through water control in the hopper 20, the nozzle 36 may be eliminated.

The screen 38 is provided for separating the sand 18 from the solids 16. The screen 38 is of conventional design and is sized to allow the particles of a selected size to readily pass therethrough. The mesh of the screen 38 may be selected to allow sand 18 to pass through. It is understood that mesh of the screen 38 can be varied dependent on the size of the prevalent particles 18 and further may have interchangeable components to provide for alterations to customize the invention 10 for each job. While it is not necessary in the practice of the invention, multiple screens 38 may be provided so that the solids 16 are separated into three or more piles or groups. Multiple screens may be advantageous when the solids 16 are to be separated into, for example, sand 18, pea gravel, and coarse aggregate 44. The upper end of the auger housing 32 terminates in an open end with an attached chute 40 for directing the flow of the remaining solids 16 into a collection pile of the remaining coarse aggregate 44.

The drive source 34 may be any conventional power source capable of rotating the auger 30 at the selected speed. The drive source 34 should have sufficient power to maintain approximately the same rotational speed of the auger 30 whether the auger 30 is unloaded and merely churning water, or the auger 30 is fully loaded and moving a maximum load of solids 16. Suitable drive sources 34 would include electric motors, hydraulic motors, stationary or movable internal combustion engines. It is understood that some drive source 34 power supplies will require gear reduction or clutching. The aforementioned drive source 34 power supplies are well known in the art and readily available from numerous sources.

The reclaimer 10 may be scaled up or down in size dependent on the particular application. However, if made too small, the reclaimer 10 will become inefficient and no longer useful. Likewise, should the reclaimer 10 be scaled up to too large size, it will become difficult to use due to the large size. Additional capacity to process can obtained without significant increase in the size of the reclaimer 10 by duplicating the auger assemble 14 so that the hopper 20 is serviced by two or more auger assemblies 14 effectively doubling the capacity of the reclaimer 10.

In its use, the reclaimer 10 is set up at a suitable location and the hopper 20 is filled with water 28. A power supply is connected to the drive source 34. Now the reclaimer 10 is ready to receive the wet, used concrete or other material to be washed and/or seperated. Power is applied and the auger 30 rotates within the auger housing 32. While it is not part of the invention, it is understood that some intervention by a user is required to place the material into the hopper 20. It is anticipated the haulers, such as a ready-mix truck would be emptied and washed into the hopper 20 where the material can be separated and reclaimed.

The material is placed into the hopper 20 with the auger 30 rotating. The material, such as concrete, tends to separate into concrete solids 16 which settle to the bottom of the hopper 30 and the excess water tends to float the lighter and smaller cement particles to the surface of the water 18. The solids 16 are agitated by the auger 30 and pulled upwardly along the angled sides 24 and above the surface of the water. As the solids 16 pass the wash water nozzle 36 they are washed removing more of the residual washable components. The residue is carried by the wash water down the auger housing and back into the hopper 20. The solids 16 continue upwardly along the auger housing 32 being carried by the auger 30. As the solids 16 are carried upwardly by the auger 30 residual water drains down the auger housing 32 and back into the hopper 20. The solids 16 continue upwardly along the auger housing 32 to the screen 38 where the sand 18 passed through the screen 38 and is collected in a pile thereunder.

The remaining solids 16, now without sand 18 continue up the auger to the upper end of the auger 30 where the remaining solids 16 are deposited in the discharge chute 40 for deposition in an aggregate collection pile 42.

While the solids 16 are settling to the bottom of the hopper 20, the cement or other such reidue is becoming suspended in the water 18 and moving toward the surface of the water where the overflow weir 22 skims the surface water with its load of particles from the water 18. The overflow water is then removed and the material is separately reclaimed and the water 18 recycled.

Periodically, depending on the quantity of material being reclaimed, the sand 18 collected beneath the screen and the aggregate pile 42 will require user intervention to remove the collected components before the piles rise up to the auger housing 32 and interfere with separation of the solids 16 into the component parts.

Although the present invention has been described with reference to preferred embodiments, workers skilled in the art will recognize changes may be made in form and detail without departing from the spirit and scope of the invention. For instance, while reference has been made to reclaiming cement, the present invention is not so limited in practical use.

What is claimed is:

1. A device for separating comprising:
a. a hopper for receiving material to be separated, the hopper having angled sites meeting in a bottom vertex the hopper further having an overflow for communicating excess water from the hopper;
b. an inclined rotating screw auger affixed adjacent to a vertex of the angled hopper sides;
c. an at least partially cylindrical auger housing extending from an edge of the hopper parallel to the angled screw auger to at least partially surround the screw auger, the auger housing further having at least one water inlet located therealong, and at least one screen section located on the lower portion of the auger housing above the at least one water inlet, the screen section being secured to and rotating with the auger; and
d. drive means for rotating the screw auger at a settable rate.

2. The invention as described in claim 1 wherein the hopper is formed as an inverted tetrahedron.

3. The invention as described in claim 2 wherein the tetrahedron is irregular.

4. The invention as described in claim 1 wherein the hopper overflow further comprises a weir.

5. The invention as described in claim 1 wherein the overflow comprises a pipe attached vertically to a hopper side and extending therethrough for communicating excess water from the hopper.

6. The invention as described in claim 1 wherein the hopper further has a plurality of overflows.

7. The invention as described in claim 1 wherein the auger housing is a discrete member extending into the hopper, terminating proximate the end of the auger.

8. The invention as described in claim 1 wherein a portion of the auger housing is formed in the angled sides of the hopper.

9. The invention as described in claim 1 wherein the water inlet for the auger housing further comprises a water nozzle.

10. The invention as described in claim 9 wherein the water inlet for the auger housing further comprises a plurality of water nozzles.

11. The invention as described in claim 1 wherein the auger housing further comprises one screen section.

12. The invention as described in claim 1 wherein the auger housing further comprises a plurality of screen sections, each of said screens section having a different mesh size.

13. The invention as described in claim 1 further comprising a plurality of inclined rotating screw augers affixed adjacent the angled hopper sides.

14. A process for reclaiming wet mixed concrete comprising the steps of:
a. introducing the wet concrete mixture into a water filled hopper having angled sides and an overflow;
b. rotating an angled housed auger extending from the bottom of the hopper out of the hopper to remove the sand and aggregate portions of the concrete while suspending the cement in an excess of water;
c. drawing the sand and aggregate up the auger past an additional washing water supply;
d. drawing the sand and aggregate up the auger past a screen in the auger housing to allowing the smaller particles to pass through the screen; and
e. drawing the remaining aggregate past the end of the auger to collect the coarse aggregate fraction.

15. The process as described in claim 14 including the further step of passing the water through a weir and thence into the overflow.

16. The process as described in claim 14 including the further step of agitating the wet concrete mixture with a rotating screw auger.

17. The process as described in claim 14 including the further step passing the sand and aggregate mixture over a plurality of screens to separate the sand and aggregate mixture in to a plurality of sized components.

18. A device for separating comprising:
a. a hopper for receiving material to be separated;
b. an inclined rotating screw auger affixed adjacent to at least one hopper side, and
c. a screen portion secured to and rotatable with the auger; and
d. drive means for rotating the screw auger at a settable rate.

19. The invention of claim 18 wherein the hopper is filled with water.
